(19) United States
(12) Patent Application Publication
(10) Pub. No.: US 2022/0371303 A1
(43) Pub. Date: Nov. 24, 2022

(54) CONNECTING TAPE MICROSTRUCTURE AND MANUFACTURING METHOD THEREOF

(71) Applicants: Interface Technology (ChengDu) Co., Ltd., Sichuan (CN); Interface Optoelectronics (ShenZhen) Co., Ltd., Guangdong (CN); General Interface Solution Limited, Miaoli County (TW)

(72) Inventor: Ying-Hui TSENG, Guangdong (CN)

(21) Appl. No.: 17/358,013

(22) Filed: Jun. 25, 2021

(30) Foreign Application Priority Data
May 19, 2021 (CN) 202110545792.0

(51) Int. Cl. B32B 15/092; B32B 27/08; B32B 27/18; B32B 5/10; B32B 27/38; C09J 7/22

(52) U.S. Cl. CPC B32B 15/092; B32B 27/08; B32B 27/18; B32B 5/10; B32B 27/38; C09J 7/22; B32B 2307/546; B32B 2307/306; B32B 2405/00; B32B 2250/03; B32B 2250/40; B32B 2262/106; B32B 2260/046; B32B 2260/021

(57) ABSTRACT

A connecting tape microstructure includes a reinforced layer and two plastic layers. The reinforced layer has a first Young's modulus. The plastic layers are disposed on two opposite sides of the reinforced layer. Each of the plastic layers has a second Young's modulus. The first Young's modulus is larger than the second Young's modulus.

### RELATED APPLICATIONS

This application claims priority to Chinese Application Serial Number 202110545792.0 filed May 19, 2021, which is herein incorporated by reference.

### BACKGROUND

### Technical Field

The present disclosure relates to connecting tape microstructures and the method to manufacture these connecting tape microstructures.

### Description of Related Art

Inside various electrical equipment or electronic devices, tapes are common measures to connect different parts or components together in order to fix their relative positions. Generally, tapes are very thin so that they can occupy less space. Moreover, the application of tapes can be single-sided or double-sided.

When only one side of a tape is sticky, the tape is used to stick on the surfaces of two adjacent parts or components. When both sides of a tape are sticky, the tape is used to stick between two adjacent parts or components.

However, inside various electrical equipment or electronic devices, there may be factors such as high temperature or vibration, which would affect the performance of the tapes. Therefore, how to increase the durability of the tapes in different working environments is undoubtedly an important issue of the industry.

### SUMMARY

A technical aspect of the present disclosure is to provide a connecting tape microstructure, which is unlikely to deform under a force, thus having a better working performance.

According to an embodiment of the present disclosure, a connecting tape microstructure includes a reinforced layer and two plastic players. The reinforced layer has a first Young's modulus. The plastic layers are disposed on two opposite sides of the reinforced layer. Each of the plastic layers has a second Young's modulus. The first Young's modulus is larger than the second Young's modulus.

In one or more embodiments of the present disclosure, the reinforced layer is metal.

In one or more embodiments of the present disclosure, the reinforced layer is carbon fiber reinforced polymer.

In one or more embodiments of the present disclosure, the plastic layers are epoxy resin.

In one or more embodiments of the present disclosure, the reinforced layer and the plastic layers respectively extend along a first direction. The reinforced layer has a first width along a second direction. The second direction is perpendicular with the first direction. Each of the plastic layers has a second width along the second direction. The second widths are the same as the first width.

In one or more embodiments of the present disclosure, the reinforced layer has two first side surfaces. The first side surfaces are opposite with each other. The first side surfaces respectively extend along a first direction. Each of the plastic layers has two second side surfaces. The second side surfaces are opposite with each other. The second side surfaces respectively extend along the first direction. Each of the second side surfaces mutually aligns with an adjacent one of the first side surfaces.

In one or more embodiments of the present disclosure, the reinforced layer has a first thickness. Each of the plastic layers has a second thickness. The first thickness is larger than each of the second thicknesses by more than two times.

In one or more embodiments of the present disclosure, a range of the second thickness of each of the plastic layers is between 5 microns and 10 microns.

According to another embodiment of the present disclosure, a method of manufacturing a connecting tape microstructure includes: (1) polishing two opposite surfaces of a reinforced layer, the reinforced layer having a first Young's modulus; and (2) disposing one of a plurality of plastic layers on each of the surfaces, each of the plastic layers having a second Young's modulus. The first Young's modulus is larger than the second Young's modulus.

In one or more embodiments of the present disclosure, the reinforced layer is metal.

In one or more embodiments of the present disclosure, the reinforced layer is carbon fiber reinforced polymer.

In one or more embodiments of the present disclosure, the plastic layers are epoxy resin.

In one or more embodiments of the present disclosure, the reinforced layer and the plastic layers respectively extend along a first direction. The reinforced layer has a first width along a second direction. The second direction is perpendicular with the first direction. Each of the plastic layers has a second width along the second direction. The second widths are the same as the first width.

In one or more embodiments of the present disclosure, the reinforced layer has two first side surfaces. The first side surfaces are opposite with each other. The first side surfaces respectively extend along a first direction. Each of the plastic layers has two second side surfaces. The second side surfaces are opposite with each other. The second side surfaces respectively extend along the first direction. Each of the second side surfaces mutually aligns with an adjacent one of the first side surfaces.

In one or more embodiments of the present disclosure, the reinforced layer has a first thickness. Each of the plastic layers has a second thickness. The first thickness is larger than each of the second thicknesses by more than two times.

In one or more embodiments of the present disclosure, a range of the second thickness of each of the plastic layers is between 5 microns and 10 microns.

In one or more embodiments of the present disclosure, the method further includes: (3) sticking at least one of the plastic layers on a high-temperature object.

In one or more embodiments of the present disclosure, the high-temperature object is a heat dissipating module.

In one or more embodiments of the present disclosure, the high-temperature object is a cooling system.

In one or more embodiments of the present disclosure, the high-temperature object is a drying device.

When compared with the prior art, the above-mentioned embodiments of the present disclosure have at least the following advantage:

(1) By sandwiching the reinforced layer between two of the plastic layers, provided that the first Young's modulus of the reinforced layer is larger than the second Young's modulus of each of the plastic layers, the connecting tape microstructure has a stronger stiffness. Thus, the connecting tape microstructure is unlikely to deform under a force, facilitating the enhancement of the working performance of the connecting tape microstructure.

(2) No matter the environment is at room temperature or at high temperature, the connecting tape microstructure can still maintain a high value of the overall Young's modulus. That is, the connecting tape microstructure has a stronger stiffness than a general die attach film. In other words, the connecting tape microstructure is unlikely to deform under a force at a high temperature, facilitating the enhancement of the working performance of the connecting tape microstructure. Thus, the scope of application of the connecting tape microstructure is substantially wide, which can lead to sufficient convenience of usage to the users.

### BRIEF DESCRIPTION OF THE DRAWINGS

The disclosure can be more fully understood by reading the following detailed description of the embodiments, with reference made to the accompanying drawings as follows:

FIG. 1 is a flow diagram of a manufacturing method of a connecting tape microstructure according to an embodiment of the present disclosure;

FIG. 2 is a schematic view of the reinforced layer of FIG. 1;

FIGS. 3-4 are schematic views of the manufacturing process of the connecting tape microstructure of FIG. 1;

FIG. 5 is a schematic view of deformation of the connecting tape microstructure of FIG. 1 under a force; and

FIG. 6 is a graph of variation of the overall Young's modulus of the connecting tape microstructure of FIG. 1 at different temperatures.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

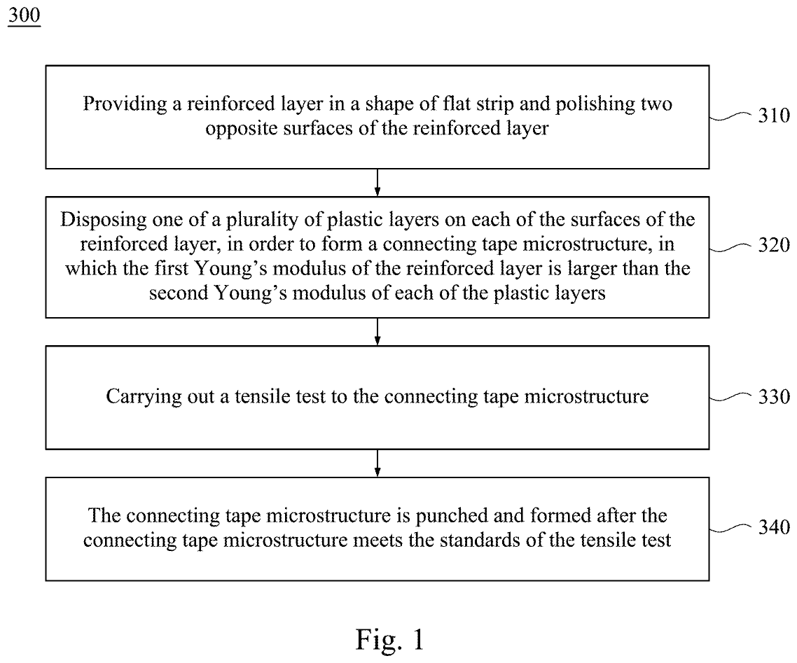

Reference is made to FIG. 1. FIG. 1 is a flow diagram of a manufacturing method 300 of a connecting tape microstructure 100 according to an embodiment of the present disclosure. In this embodiment, as shown in FIG. 1, a manufacturing method 300 includes the following operations (it is appreciated that the sequence of the operations and the sub-operations as mentioned below, unless otherwise specified, can all be adjusted upon the actual needs, or even executed at the same time or partially at the same time):

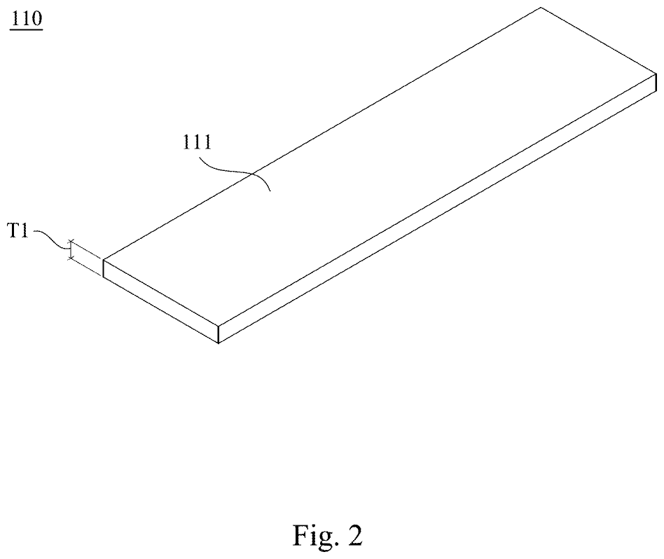

(1) Providing a reinforced layer 110 in a shape of flat strip and polishing two opposite surfaces 111 of the reinforced layer 110 (Operation 310), such that each of the surfaces 111 of the reinforced layer 110 has an appropriate degree of roughness. Reference is made to FIG. 2. FIG. 2 is a schematic view of the reinforced layer 110 of FIG. 1. In this embodiment, as shown in FIG. 2, the reinforced layer 110 has two opposite surfaces 111 (as the two surfaces 111 are opposite to each other, only one of the surfaces 111 is shown in FIG. 2; another one of the surfaces 111 is located at the back of the reinforced layer 110 and is not shown in FIG. 2) and is in a shape of flat strip. The reinforced layer 110 has a first thickness T1. In practical applications, the first thickness T1 of the reinforced layer 110 is of a level of microns.

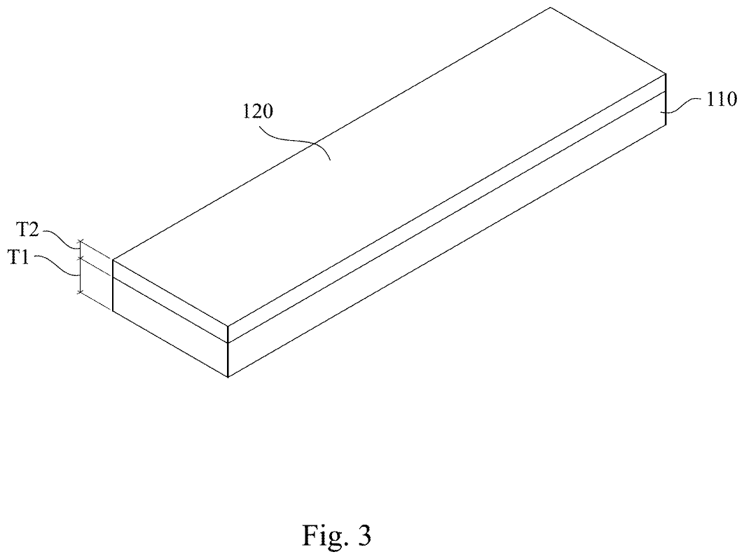

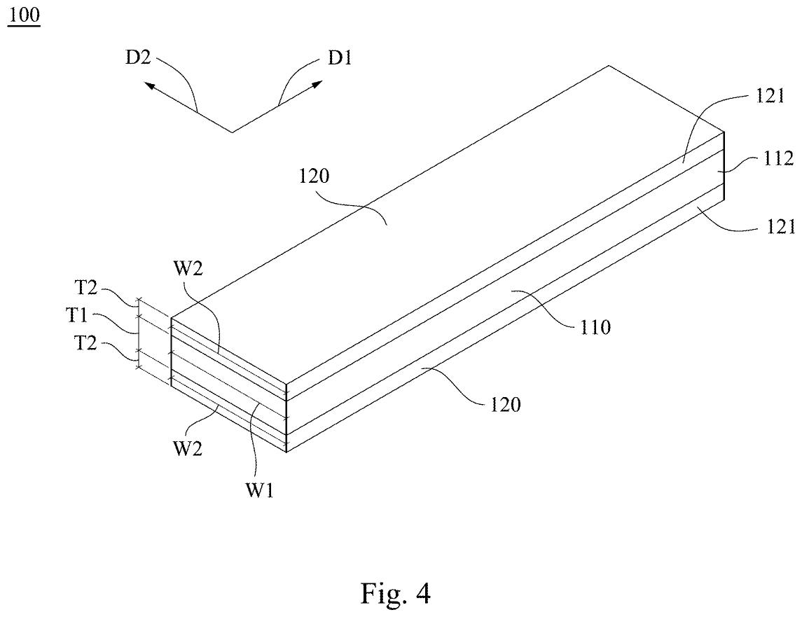

(2) Disposing one of a plurality of plastic layers 120 on each of the surfaces 111 of the reinforced layer 110, in order to form a connecting tape microstructure 100 (Operation 320). Reference is made to FIGS. 3-4. FIGS. 3-4 are schematic views of the manufacturing process of the connecting tape microstructure 100 of FIG. 1. In this embodiment, as shown in FIGS. 3-4, the two plastic layers 120 are sequentially disposed on the surfaces 111 of the reinforced layer 110, in order to form a connecting tape microstructure 100 (as shown in FIG. 4). In other words, the two plastic layers 120 are disposed on two opposite sides of the reinforced layer 110.

To be specific, in practical applications, after the surfaces 111 of the reinforced layer 110 are polished, each of the surfaces 111 of the reinforced layer 110 is attached with a double-sided tape or applied with a glue, and the plastic layers 120 are attached and fixed on the surfaces 111 of the reinforced layer 110. However, it is noted that, the method to attach and fix the plastic layers 120 on the reinforced layer 110 as cited here are only illustrative and do not intend to limit the present disclosure. A person having ordinary skill in the art of the present disclosure may suitably choose the method to attach and fix the plastic layers 120 on the reinforced layer 110, depending on the actual situations.

In addition, as shown in FIG. 4, the plastic layers 120 are respectively in a shape of flat strip. Each of the plastic layers 120 has a second thickness T2. The second thickness T2 of each of the plastic layers 120 is of a level of microns. Therefore, the overall thickness of the connecting tape microstructure 100 formed from sandwiching the reinforced layer 110 between the two plastic layers 120 is also of a level of microns. Moreover, the second thicknesses T2 of the two plastic layers 120 can be the same as each other or different from each other. However, this does not intend to limit the present disclosure.

In this embodiment, more preferably, the first thickness T1 of the reinforced layer 110 is larger than the second thickness T2 of each of the plastic layers 120 by more than two times. In practical applications, a range of the second thickness T2 of each of the plastic layers 120 is between 5 microns and 10 microns. For example, when the second thickness T2 of each of the plastic layers 120 is 5 microns, the first thickness T1 of the reinforced layer 110 is larger than 10 microns. When the second thickness T2 of each of the plastic layers 120 is 10 microns, the first thickness T1 of the reinforced layer 110 is larger than 20 microns. However, it is noted that, the range of the first thickness T1 of the reinforced layer 110 and the range of the second thickness T2 of each of the plastic layers 120 as cited here are only illustrative and do not intend to limit the present disclosure. A person having ordinary skill in the art of the present disclosure may suitably choose the first thickness T1 of the reinforced layer 110 and the second thickness T2 of each of the plastic layers 120, depending on the actual situations such as the current level of craft.

It is worth to note that, in this embodiment, the reinforced layer 110 has a first Young's modulus. Each of the plastic layers 120 has a second Young's modulus. The first Young's modulus of the reinforced layer 110 is larger than the second Young's modulus of each of the plastic layers 120. In other words, the reinforced layer 110 has a stronger stiffness relative to each of the plastic layers 120. When under a force, the reinforced layer 110 is unlikely to deform relative to each of the plastic layers 120.

In addition, structurally speaking, as shown in FIG. 4, the reinforced layer 110 has two opposite first side surfaces 112 (as the two first side surfaces 112 are opposite to each other, only one of the first side surfaces 112 is shown in FIG. 4; another one of the first side surfaces 112 is located at the back of the reinforced layer 110 and is not shown in FIG. 4). The first side surfaces 112 respectively extend along a first direction D1. Each of the plastic layers 120 has two opposite second side surfaces 121 (as the two second side surfaces 121 of each of the plastic layers 120 are opposite to each other, only one of the second side surfaces 121 is shown in FIG. 4 for each of the plastic layers 120; another one of the second side surfaces 121 is located at the back of the corresponding plastic layer 120 and is not shown in FIG. 4). The second side surfaces 121 also respectively extend along the first direction D1. The operation to dispose one of a plurality of plastic layers 120 on each of the surfaces 111 of the reinforced layer 110 (i.e., Operation 320) further includes the following subsidiary operation:

(2.1) Aligning one of the second side surfaces 121 with the corresponding one of the first side surface 112 (Operation 321). In other words, when attaching and fixing each of the plastic layers 120 on the reinforced layer 110, each of the second side surfaces 121 of each of the plastic layers 120 mutually aligns with an adjacent one of the first side surfaces 112 of the reinforced layer 110.

In addition, as mentioned above, the first side surfaces 112 of the reinforced layer 110 and the second side surfaces 121 of each of the plastic layers 120 respectively extend along the first direction D1. This means, the reinforced layer 110 and the plastic layers 120 respectively extend along the first direction Dl. The reinforced layer 110 has a first width W1 along a second direction D2. The second direction D2 is perpendicular with the first direction D1. To be specific, the first width W1 is a distance between the two opposite first side surfaces 112 along the second direction D2. Moreover, each of the plastic layers 120 has a second width W2 along the second direction D2. Similarly, the second width W2 is a distance between the two opposite second side surfaces 121 along the second direction D2. As mentioned above, since each of the second side surfaces 121 of each of the plastic layers 120 mutually aligns with an adjacent one of the first side surfaces 112 of the reinforced layer 110, the second width W2 of each of the plastic layers 120 is the same as the first width W1 of the reinforced layer 110.

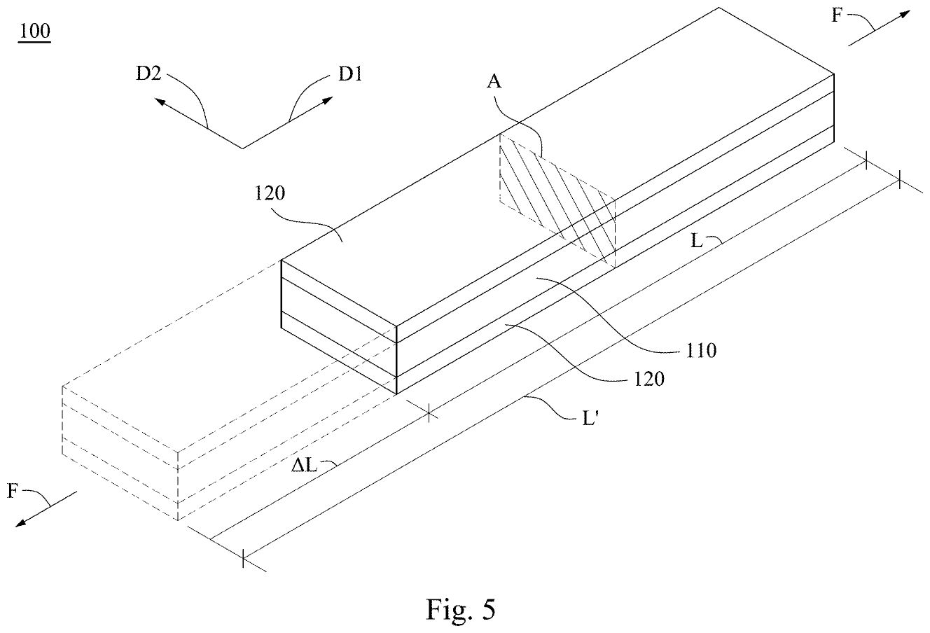

Reference is made to FIG. 5. FIG. 5 is a schematic view of deformation of the connecting tape microstructure 100 of FIG. 1 under a force. In this embodiment, as shown in FIG. 5, when the connecting tape microstructure 100 is pulled by a force F along the first direction D1, the connecting tape microstructure 100 is elongated from the original length L to the new length L′along the first direction D1, producing a change of length ΔL. In other words, the change of length ΔL is the difference between the new length L′ and the original length L. Moreover, as shown in FIG. 5, the change of length ΔL is presented by hidden lines. For the sake of easy understanding of the figure, the magnitude of the change of length ΔL is presented in an exaggerated manner. As mentioned above, since the connecting tape microstructure 100 is formed from sandwiching the reinforced layer 110 between the two plastic layers 120, and the first Young's modulus of the reinforced layer 110 is larger than the second Young's modulus of each of the plastic layers 120, as compared with another connecting tape microstructure (not shown) formed from only a singular one of the plastic layer 120 but having the same dimensions as the connecting tape microstructure 100, the change of length ΔL produced by the connecting tape microstructure 100 will be smaller upon the same pulling force F. In other words, by sandwiching the reinforced layer 110 between two of the plastic layers 120, provided that the first Young's modulus of the reinforced layer 110 is larger than the second Young's modulus of each of the plastic layers 120, the connecting tape microstructure 100 has a stronger stiffness. Thus, the connecting tape microstructure 100 is unlikely to deform under a force, facilitating the enhancement of the working performance of the connecting tape microstructure 100.

To be more specific, when the connecting tape microstructure 100 is pulled by the force F along the first direction D1, since the plastic layers 120 are attached and fixed on the surfaces 111 of the reinforced layer 110, the reinforced layer 110 and the plastic layers 120 are respectively pulled from the original length L to the new length L′, producing the change of length ΔL. The reinforced layer 110 and the plastic layers 120 bear together the tension by the force F.

As a whole, as shown in FIG. 5, the reinforced layer 110 and the plastic layers 120 define together a cross-sectional area A of the connecting tape microstructure 100. The cross-sectional area A is perpendicular to the first direction D1. As mentioned above, since each of the second side surfaces 121 of each of the plastic layers 120 mutually aligns with an adjacent one of the first side surfaces 112 of the reinforced layer 110, and the second width W2 of each of the plastic layers 120 is the same as the first width W1 of the reinforced layer 110, in this embodiment, the cross-sectional area A of the connecting tape microstructure 100 is of a rectangular shape.

Furthermore, for the sake of understanding and analysis, the connecting tape microstructure 100 can be considered as a singular structure in a simplified manner. When the connecting tape microstructure 100 is pulled by the force F along the first direction D1, the stress a of the connecting tape microstructure 100 produced is the quotient obtained from dividing the force F by the cross-sectional area A. This means, the stress σ=the force F/the cross-sectional area A. At this point, the connecting tape microstructure 100 increases by the change of length ΔL from the original length L to the new length L′, and the strain ε of the connecting tape microstructure 100 produced is the quotient obtained from dividing the change of length ΔL by the original length L. This means, the strain ε=the change of length ΔL/the original length L. According to Hooke's Law, the Young's modulus of the connecting tape microstructure 100 is the quotient obtained by dividing the stress σ by the strain ε. This means, the Young's modulus E of the connecting tape microstructure 100=the stress σ/the strain ε. As mentioned above, since the change of length ΔL produced by the connecting tape microstructure 100 under the same pulling force F is smaller when compared with another connecting tape microstructure (not shown) formed from only a singular one of the plastic layer 120 but having the same dimensions as the connecting tape microstructure 100, the strain ε produced by the connecting tape microstructure 100 will also be relatively smaller. Thus, the Young's modulus E of the connecting tape microstructure 100 is correspondingly increased.

In practical applications, as shown in FIG. 1, the manufacturing method 300 further includes the following operations:

(4) Carrying out a tensile test to the connecting tape microstructure 100 (Operation 330). For example, in order to ensure the quality of the connecting tape microstructure 100, a dynamic mechanical analyzer can be used to carry out a tensile test to the connecting tape microstructure 100.

(5) The connecting tape microstructure 100 is punched and formed after the connecting tape microstructure 100 meets the standards of the tensile test (Operation 340). According to the actual situations, after the connecting tape microstructure 100 meets the standards of the tensile test, the connecting tape microstructure 100 is punched in order to form specific shapes.

On the other hand, in this embodiment, the reinforced layer 110 can be metal. For example, the reinforced layer 110 can be copper. However, it is noted that, the metal type of the reinforced layer 110 as cited here is only illustrative and does not intend to limit the present disclosure. A person having ordinary skill in the art of the present disclosure may suitably choose the metal type of the reinforced layer 110, depending on the actual situations.

In this embodiment, the plastic layers 120 can be epoxy resin. However, it is noted that, the material type of the plastic layers 120 as cited here is only illustrative and does not intend to limit the present disclosure. A person having ordinary skill in the art of the present disclosure may suitably choose the material type of the plastic layers 120, depending on the actual situations.

In other embodiments, the reinforced layer 110 can be non-metal. For example, the reinforced layer 110 can be carbon fiber reinforced polymer. However, it is noted that, the non-metallic material type of the reinforced layer 110 as cited here is only illustrative and does not intend to limit the present disclosure. A person having ordinary skill in the art of the present disclosure may suitably choose the non-metallic material type of the reinforced layer 110, depending on the actual situations.

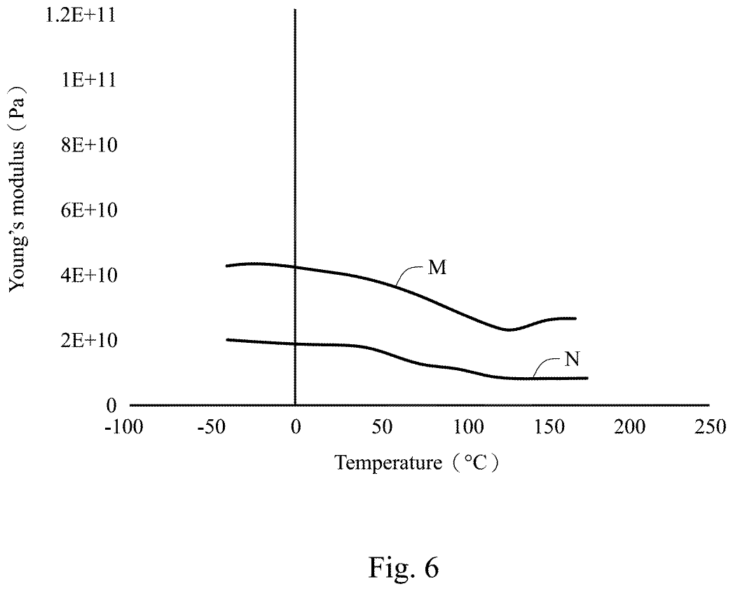

Reference is made to FIG. 6. FIG. 6 is a graph of variation of the overall Young's modulus E of the connecting tape microstructure 100 of FIG. 1 at different temperatures. As shown in FIG. 6, the curve M presents the variation of the overall Young's modulus E of the connecting tape microstructure 100 with regard to the variation of temperature, provided that the reinforced layer 110 and the plastic layers 120 of the connecting tape microstructure 100 are respectively copper and epoxy resin. For example, when the connecting tape microstructure 100 is at room temperature of 25 degree Celsius, the overall Young's modulus E of the connecting tape microstructure 100 is about 40 GPa. When the connecting tape microstructure 100 is at a high temperature of 90 degree Celsius, the overall Young's modulus E of the connecting tape microstructure 100 is about 29.8 GPa. Moreover, as shown in FIG. 6, the curve N presents the variation of Young's modulus of a general die attach film (DAF) with regard to the variation of temperature. As compared to the Young's modulus of a general die attach film, the overall Young's modulus E of the connecting tape microstructure 100 is increased by nearly 3 times. In other words, it can be known from experimental data that, no matter the environment is at room temperature or at high temperature, the connecting tape microstructure 100 can still maintain a high value of the overall Young's modulus E. That is, the connecting tape microstructure 100 has a stronger stiffness than a general die attach film. In other words, the connecting tape microstructure 100 is unlikely to deform under a force at a high temperature, facilitating the enhancement of the working performance of the connecting tape microstructure 100.

In practical applications, the connecting tape microstructure 100 can be widely applied inside various electrical equipment or electronic devices. For example, the connecting tape microstructure 100 can be applied to a heat dissipating module (not shown) having a high working temperature, and is configured to connect with vibrating or moving units inside the heat dissipating module. To be specific, the plastic layer(s) 120 of the connecting tape microstructure 100 can be attached with a double-sided tape or applied with a glue. Afterwards, according to the actual situations, the connecting tape microstructure 100 is attached and fixed to the surfaces of two adjacent parts or components inside the heat dissipating module, or attached and fixed between two adjacent parts or components inside the heat dissipating module. As mentioned above, since the connecting tape microstructure 100 can still maintain a high value of the overall Young's modulus E in an environment of a high temperature, the heat dissipating module is facilitated to maintain the resonance frequency required. Moreover, poor contact caused by factors such as failure of screw teeth or loose screws due to vibration, which could reduce the resonance effect to provide requirement for thinness, can be avoided.

On the other hand, for example, the connecting tape microstructure 100 can also be applied to a cooling system (not shown) having a high working temperature, and is configured to connect with vibrating or moving units inside the cooling system. To be specific, the plastic layer(s) 120 of the connecting tape microstructure 100 can be attached with a double-sided tape or applied with a glue. Afterwards, according to the actual situations, the connecting tape microstructure 100 is attached and fixed to the surfaces of two adjacent parts or components inside the cooling system, or attached and fixed between two adjacent parts or components inside the cooling system. As mentioned above, since the connecting tape microstructure 100 can still maintain a high value of the overall Young's modulus E in an environment of a high temperature, through the stable and highly efficient output volume of air, the temperature of the environment can be greatly reduced.

Moreover, for example, the connecting tape microstructure 100 can also be applied to a drying device (not shown) having a high working temperature, and is configured to connect with vibrating or moving units inside the drying device. To be specific, the plastic layer(s) 120 of the connecting tape microstructure 100 can be attached with a double-sided tape or applied with a glue. Afterwards, according to the actual situations, the connecting tape microstructure 100 is attached and fixed to the surfaces of two adjacent parts or components inside the drying device, or attached and fixed between two adjacent parts or components inside the drying device. As mentioned above, since the connecting tape microstructure 100 can still maintain a high value of the overall Young's modulus E in an environment of a high temperature, through the high air volume provided by the drying device in a silent mode (low decibel), the object to be dried can achieve the effect of quick drying.

It can be known from the several examples of application of the connecting tape microstructure 100 as mentioned above, since the connecting tape microstructure 100 can still maintain a high value of the overall Young's modulus E in an environment of a room temperature of a high temperature, the scope of application of the connecting tape microstructure 100 is substantially wide, which can lead to sufficient convenience of usage to the users.

In conclusion, when compared with the prior art, the aforementioned embodiments of the present disclosure have at least the following advantage:

(1) By sandwiching the reinforced layer between two of the plastic layers, provided that the first Young's modulus of the reinforced layer is larger than the second Young's modulus of each of the plastic layers, the connecting tape microstructure has a stronger stiffness. Thus, the connecting tape microstructure is unlikely to deform under a force, facilitating the enhancement of the working performance of the connecting tape microstructure.

(2) No matter the environment is at room temperature or at high temperature, the connecting tape microstructure can still maintain a high value of the overall Young's modulus. That is, the connecting tape microstructure has a stronger stiffness than a general die attach film. In other words, the connecting tape microstructure is unlikely to deform under a force at a high temperature, facilitating the enhancement of the working performance of the connecting tape microstructure. Thus, the scope of application of the connecting tape microstructure is substantially wide, which can lead to sufficient convenience of usage to the users.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A connecting tape microstructure, comprising:
a reinforced layer having a first Young's modulus; and
two plastic layers disposed on two opposite sides of the reinforced layer, each of the plastic layers having a second Young's modulus,
wherein the first Young's modulus is larger than the second Young's modulus.

2. The connecting tape microstructure of claim 1, wherein the reinforced layer is metal.

3. The connecting tape microstructure of claim 1, wherein the reinforced layer is carbon fiber reinforced polymer.

4. The connecting tape microstructure of claim 1, wherein the plastic layers are epoxy resin.

5. The connecting tape microstructure of claim 1, wherein the reinforced layer and the plastic layers respectively extend along a first direction, the reinforced layer has a first width along a second direction perpendicular with the first direction, each of the plastic layers has a second width along the second direction, the second widths are same as the first width.

6. The connecting tape microstructure of claim 1, wherein the reinforced layer has two first side surfaces opposite with each other, the first side surfaces respectively extend along a first direction, each of the plastic layers has two second side surfaces opposite with each other, the second side surfaces respectively extend along the first direction, each of the second side surfaces mutually aligns with an adjacent one of the first side surfaces.

7. The connecting tape microstructure of claim 1, wherein the reinforced layer has a first thickness, each of the plastic layers has a second thickness, the first thickness is larger than each of the second thicknesses by more than two times.

8. The connecting tape microstructure of claim 7, wherein a range of the second thickness of each of the plastic layers is between 5 microns and 10 microns.

9. A method of manufacturing a connecting tape microstructure, comprising:
polishing two opposite surfaces of a reinforced layer, the reinforced layer having a first Young's modulus; and
disposing one of a plurality of plastic layers on each of the surfaces, each of the plastic layers having a second Young's modulus,
wherein the first Young's modulus is larger than the second Young's modulus.

10. The method of claim 9, wherein the reinforced layer is metal.

11. The method of claim 9, wherein the reinforced layer is carbon fiber reinforced polymer.

12. The method of claim 9, wherein the plastic layers are epoxy resin.

13. The method of claim 9, wherein the reinforced layer and the plastic layers respectively extend along a first direction, the reinforced layer has a first width along a second direction perpendicular with the first direction, each of the plastic layers has a second width along the second direction, the second widths are same as the first width.

14. The method of claim 9, wherein the reinforced layer has two first side surfaces opposite with each other, the first side surfaces respectively extend along a first direction, each of the plastic layers has two second side surfaces opposite with each other, the second side surfaces respectively extend along the first direction, each of the second side surfaces mutually aligns with an adjacent one of the first side surfaces.

15. The method of claim 9, wherein the reinforced layer has a first thickness, each of the plastic layers has a second thickness, the first thickness is larger than each of the second thicknesses by more than two times.

16. The method of claim 15, wherein a range of the second thickness of each of the plastic layers is between 5 microns and 10 microns.

17. The method of claim 9, further comprising:
sticking at least one of the plastic layers on a high-temperature object.

18. The method of claim 17, wherein the high-temperature object is a heat dissipating module.

19. The method of claim 17, wherein the high-temperature object is a cooling system.

20. The method of claim 17, wherein the high-temperature object is a drying device.
